(19) United States
(12) Patent Application Publication
(10) Pub. No.: US 2018/0009590 A1
(43) Pub. Date: Jan. 11, 2018

(54) Portable Feeding Bottle

(71) Applicant: Ka Po Wong, Tai Po (HK)

(72) Inventors: Ka Po Wong, Tai Po (HK); Wing Sze Wong, Tai Po (HK); Ho Yee Yim, Tai Po (HK)

(73) Assignee: Ka Po Wong, Tai Po (HK)

(21) Appl. No.: 15/438,580

(22) Filed: Feb. 21, 2017

(30) Foreign Application Priority Data
Jul. 7, 2016 (CN) 201610533928.5

(51) Int. Cl. B65D 81/32; B65D 41/04; B65D 1/02; B65D 43/02; A61J 9/00

(52) U.S. Cl. CPC B65D 81/3211; B65D 43/02; A61J 9/00; B65D 1/0246; B65D 41/04

(57) ABSTRACT

A portable container, which contains a lower container body for storing a liquid, and an upper container body detachably connected to the lower container body. The upper container body adapted to store solid substance. The upper container body further contains a user-configurable opening device which is switchable between a first state and a second state. In the first state the opening device prevents the solid substance in the upper container body from falling into the lower container body. In the second state the opening device allows the solid substance to fall into the lower container body in order to mix with the liquid. The portable container not only separates the milk powder and warm water before brewing, but it also maintains the water at an appropriate temperature and to maintain the dryness of the milk powder. The warm water and the milk powder can then be mixed at any time to brew the milk suitable for drinking.

### TECHNICAL FIELD

The present invention relates to a container for storing liquids, and in particular a portable container which is suitable for hand-holding.

### BACKGROUND ART

On the market currently there are various baby feeding products for consumers to select, such as milk powder boxes, feeding bottles, and vacuum flasks. Usually, when parents and their children go out to street, they need to bring more than one of the above baby feeding products, since each of these baby feeding products carries out a different function where people cannot just omit any one of them. This results in too much belongings to be carried by the parents, and the heavy weights cause inconvenience as well. In addition, preparing milk in outside environments is a too complicated process and the steps are cumbersome. Pouring milk powder and brewing water during the process may also give rise to hygiene problems.

### SUMMARY OF INVENTION

Therefore, embodiments of the present invention provide an improved portable container for brewing milk at any time while going out, and which preserves the temperature of warm water as well dryness of the milk powder before brewing.

In a first aspect, the present invention provides a portable container, which contains a lower container body for storing a liquid, and an upper container body detachably connected to the lower container body. The upper container body adapted to store solid substance. The upper container body further contains a user-configurable opening device which is switchable between a first state and a second state. In the first state the opening device prevents the solid substance in the upper container body from falling into the lower container body. In the second state the opening device allows the solid substance to fall into the lower container body in order to mix with the liquid.

Preferably, the opening device includes a first adjoining face, and a second adjoining face which is movable relative to the first adjoining face. Each of the first and second adjoining faces contains an opening. In the first state of the opening device, the opening on the first adjoining face is completely misaligned with the opening on the second adjoining face. In the second state of the opening device, the opening on the first adjoining face is at least partially aligned with the opening on the second adjoining face.

More preferably, on the first adjoining face there is configured a blocking member, which surrounds edges of the opening on the first adjoining face. The blocking member is adapted to form a seal between the opening on the first adjoining face and the opening on the second adjoining face.

In one specific implementation, the blocking member is a silicone strip.

In another specific implementation, the blocking member has a sawtooth structure on its top contacting the second adjoining face.

In a further specific implementation, a top of the blocking member contacting the second adjoining face has a smaller width as compared to a bottom of the blocking member contacting the first adjoining face.

According to one variation of the preferred embodiments, the upper container body has a circular cross-sectional shape. The first adjoining face and the second adjoining face are configured to be rotatable around a central axis of the upper container body so as to allow the opening device to switch between the first stage and the second state.

Preferably, both the first adjoining face and the second adjoining face have a conical shape.

According to another variation of the preferred embodiments, the upper container body further contains a valve part, and a storage part for storing the solid substance. The valve part is connected between the storage part and the lower container body, and the three of which are detachably connected to each other. The first adjoining face is located at the bottom of the storage part, and the second adjoining face is located at the top of an end of the valve part adjacent to the storage part.

According to a further variation of the preferred embodiments, the openings on the first adjoining face and the second adjoining face are in funnel shapes.

According to a further variation of the preferred embodiments, the opening on the first adjoining face has an area larger than that of the opening on the second adjoining face.

According to a further variation of the preferred embodiments, the portable container further includes a container lid removably connected to the upper container body.

According to a further variation of the preferred embodiments, the portable container further includes a leak-proof cover located between the container lid and the upper container body.

According to another aspect of the present invention, there is provided a method of configuring a portable container to mix solid substance with a liquid. The portable container includes an upper container body, and a lower container body detachably connected to the upper container body. The upper container body further includes a user-configurable opening device. The method contains the steps of: loading the liquid into the lower container body; configuring the opening device of the upper container body in a first state; loading the solid substance into the upper container body, and connecting the upper container body to the lower container body; and configuring the opening device of the upper container body in a second state, in which the solid substance enters the lower container body from the upper container body to mix with the liquid. The upper container body further includes a user-configurable opening device which is switchable between a first state and a second state. In the first state the opening device prevents the solid substance in the upper container body from falling into the lower container body. In the second state the opening device allows the solid substance to fall into the lower container body in order to mix with the liquid.

Preferably, the opening device includes a first adjoining face, and a second adjoining face which is movable relative to the first adjoining face. Each of the first and second adjoining faces contains an opening. In the first state of the opening device, the opening on the first adjoining face is completely misaligned with the opening on the second adjoining face. In the second state of the opening device, the opening on the first adjoining face is at least partially aligned with the opening on the second adjoining face.

More preferably, on the first adjoining face there is configured a blocking member, which surrounds edges of the opening on the first adjoining face. The blocking member is adapted to form a seal between the opening on the first adjoining face and the opening on the second adjoining face.

In one specific implementation, the blocking member is a silicone strip.

In another specific implementation, the blocking member has a sawtooth structure on its top contacting the second adjoining face.

In a further specific implementation, a top of the blocking member contacting the second adjoining face has a smaller width as compared to a bottom of the blocking member contacting the first adjoining face.

According to one variation of the preferred embodiments, the upper container body has a circular cross-sectional shape. The first adjoining face and the second adjoining face are configured to be rotatable around a central axis of the upper container body so as to allow the opening device to switch between the first stage and the second state.

Preferably, both the first adjoining face and the second adjoining face have a conical shape.

According to another variation of the preferred embodiments, the upper container body further contains a valve part, and a storage part for storing the solid substance. The valve part is connected between the storage part and the lower container body, and the three of which are detachably connected to each other. The first adjoining face is located at the bottom of the storage part, and the second adjoining face is located at the top of an end of the valve part adjacent to the storage part.

According to a further variation of the preferred embodiments, the openings on the first adjoining face and the second adjoining face are in funnel shapes.

According to a further variation of the preferred embodiments, the opening on the first adjoining face has an area larger than that of the opening on the second adjoining face.

According to a further variation of the preferred embodiments, the portable container further includes a container lid removably connected to the upper container body.

According to a further variation of the preferred embodiments, the portable container further includes a leak-proof cover located between the container lid and the upper container body.

The present invention therefore provides a portable feeding bottle which provides great conveniences for parents and children when they go out to street, as only simple steps are required to brew milk which is suitable for drinking instantly. Such a portable feeding bottle not only is able to store warm water and milk powder separately, as well as maintaining the temperature of the warm water, but also it enables controlling the mixing of the milk powder and the warm water by the slide tracks.

The portable feeding bottle as described in embodiments of the present invention includes a container lid, a leak-proof cover, storage part, valve part, and lower container body, etc. After the storage part is connected to the valve part, the openings of the two are away from each other, so that the milk powder can be placed in the storage part. When milk needs to be brewed, the storage part is rotated so that the opening on the storage part is aligned with that on the valve part, and as a result the milk powder may fall down along the funnel shape. Then, after shaking the feeding bottle thoroughly, it becomes the milk that can be drunk by the baby. The funnel shape of the storage part as designed makes the milk powder to fall down effectively without residing in the storage part. The proposed feeding bottle has a simple structure which not only separates the milk powder from warm water, but also maintains the temperature of the water at a desired level, as well as keeping the dryness of the milk powder.

### DESCRIPTION OF ACCOMPANYING DRAWINGS

Further understanding of the performance and advantages of the present invention is possible by referring to the remaining part in this specification and the accompanying drawings. In some circumstances, a child reference number is placed after a designating character and a hyphen to mean that the child reference number refers to one of many similar parts. When a reference number is used but no particular child reference number is mentioned, then this intends to refer to all of the similar parts.

FIG. 1 shows an exploded view of the portable container according to a first embodiment of the present invention.

FIG. 2 is the top view of the portable container in FIG. 1.

FIG. 3 is a cross-sectional view of the portable container in FIG. 2 along the line B-B.

FIG. 4 is a partial exploded view of the portable container in FIG. 1, in which the leak-proof cover and the lower container body are omitted.

FIG. 5 is a cross-sectional view of the portable container in FIG. 1, in which the leak-proof cover is omitted.

FIG. 6 is the perspective exploded view of the parts in FIG. 4.

FIG. 7 shows the structure of the stop on the first adjoining face on the storage part in FIGS. 1-6.

### DETAILED DESCRIPTION OF PREFERRED EMBODIMENTS

Embodiments of the present invention use a staggered structure having a funnel shape to control the falling speed of the milk powder, as well as silicone strips to prevent mutual interaction between the milk powder and the moisture. Other advantages and beneficial effects provided by embodiments of the present invention can be understood easily from the forthcoming descriptions.

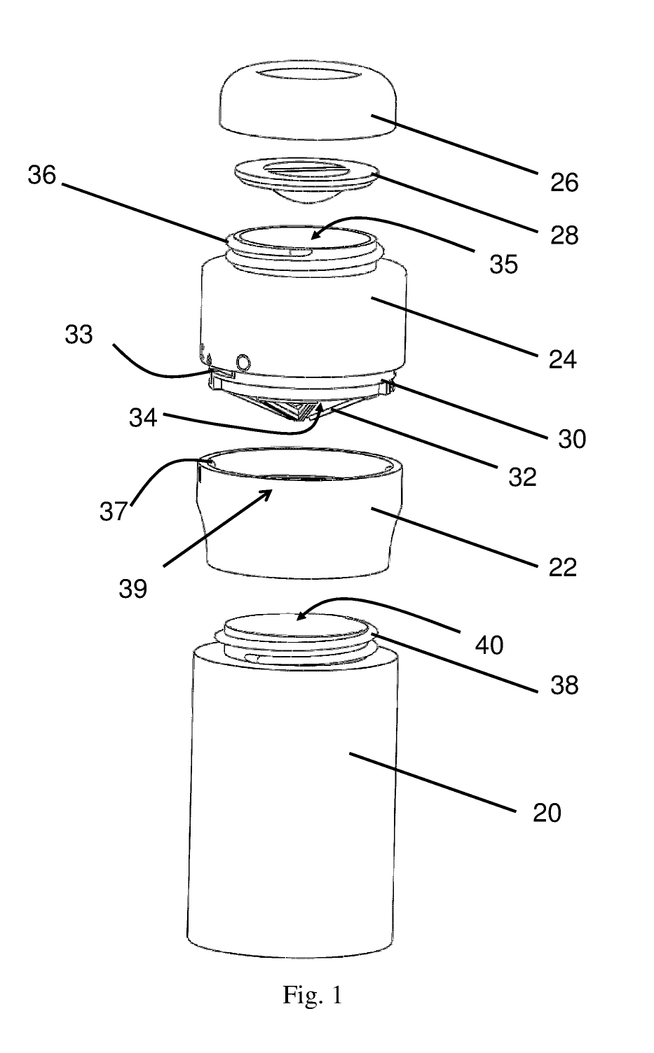

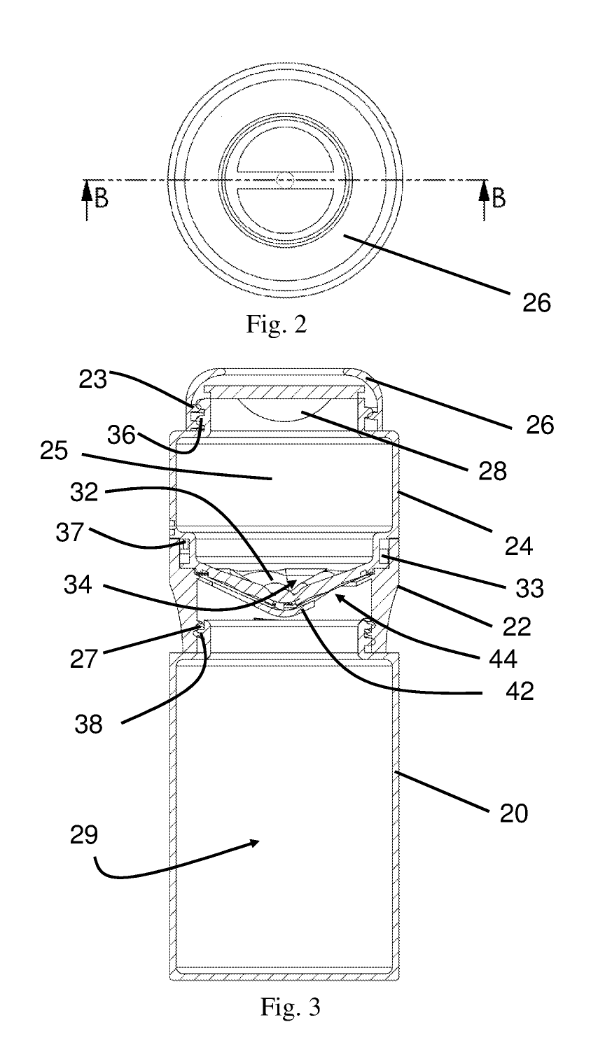

Firstly, with reference to FIGS. 1-2 the portable container disclosed by the present invention according to a first embodiment is a portable feeding bottle. The feeding bottle includes a container lid 26, a storage part 24 which has external threads 36 to cooperate with internal threads (not shown) on the container lid 26 to detachably connect to container lid 26, a valve part 22 connected to the storage part 24 by slide tracks 33 on the storage part 24, and a lower container body 20 having external threads 38 to cooperate with internal threads (not shown) on the valve part 22 so as to detachably connect to the valve part 22. The container lid 26, the storage part 24, the valve part 22 and the lower container body 20 all have a substantially cylindrical shape. That is, their cross-sections are in circular shapes.

In particular, the storage part 24 has an internal cavity (not shown) which is adapted to store solid substances such as milk powder. In addition, on top of the storage part 24 there is an opening 35 for loading the solid substance into the storage part 24. The opening 35 has a diameter smaller than that of the main body of the storage part 24. On the rim of the portion of the storage part 24 which forms the opening 35, the above-mentioned external threads 36 are formed. The storage part 24 and the valve part 22 in combination form an upper container body of the portable feeding bottle. At the bottom of the storage part 24 there is a first adjoining face 32 on which multiple openings 34 are formed. More detailed descriptions on the first adjoining face 32 will be provided later. In addition, the slide tracks 33 are formed on the exterior circumferential portion of the storage part 24 at its lower end near the first adjoining face 32. Each of the slide tracks 33 have a zigzag shape.

A leak-proof cover 28 is configured for placing on the opening 35 of the storage part 24, and is adapted to be pressed tightly onto the opening 35 when the container cover 26 is screwed tightly to the storage part 24, so that the opening 35 is completely closed without any substances leaking from the opening 35.

The valve part 22 has an annular wall 39. At the interior of the annual wall 39 there is a second adjoining face (not shown) which fits with the above-mentioned first adjoining face 32. This will be described in more details later. On the interior surface of the annual wall 39 on an end of the valve part 22 next to the storage part 24, there are two locking members 37 arranged on opposite positions (i.e. they are on the same diameter of the annual wall 39). The locking members 37 are adapted to cooperate with the above-mentioned slide tracks 33 on the storage part 24, so as to detachably connect the valve part 22 to the storage part 24, as well as to allow the valve part 22 and the storage part 24 to move relatively to each other within a certain angular range when the two are connected. This will be described in more details later. At the bottom end (which is the end near the lower container body 20) of the valve part 22 there are formed internal threads (not shown) for cooperating with the external threads 38 on the lower container body 20.

The lower container body 20 generally has a can shape. On its top there is formed an opening 40, which has a diameter small than that of the main body of the lower container body 20. On the rim of the portion of the lower container body 20 forming the opening 40, the above-mentioned external threads 38 are formed. Inside the lower container body 20 there is a cavity (not shown) suitable for storing liquids such as warm water or the brewed milk.

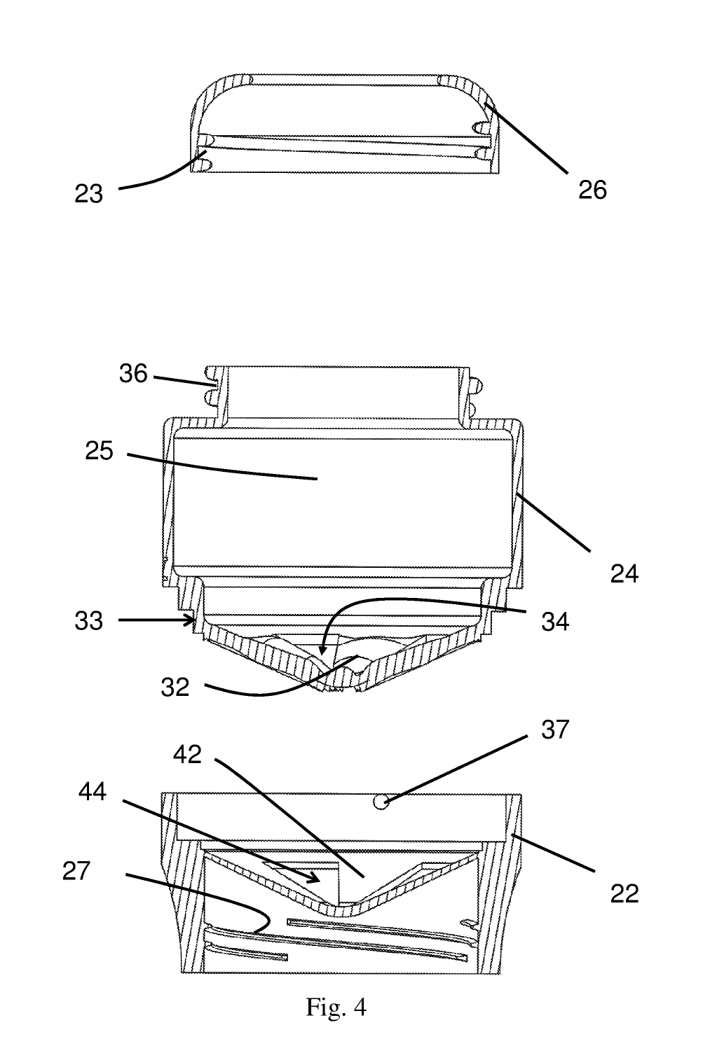

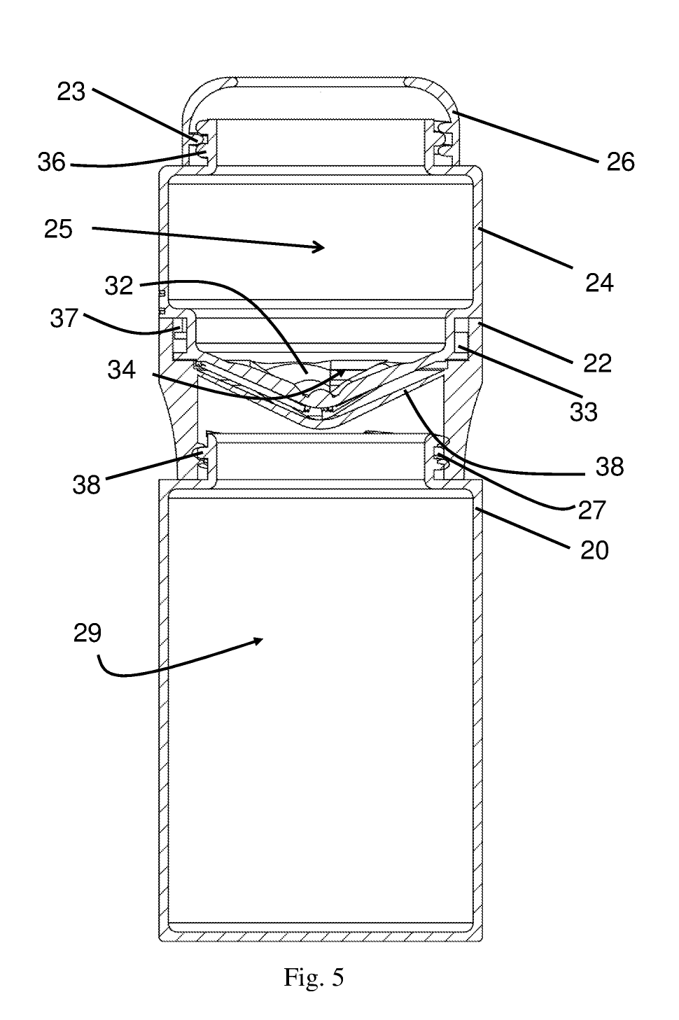

Turning now to FIGS. 3-5, in a series of cross-sectional views there are shown the internal threads 23 on the container lid 26 which may cooperate with the external thread 36 on the storage part 24. The cavity 25 inside the storage part 24 is the space for storing the solid substances such as milk powder. The slide tracks 33 on the external circumference of the lower end of the storage part 24 cooperate with the locking members 37 on the internal surface of the upper end of the valve part 22. Inside the valve part 22 there is a second adjoining face 42 on which a number of openings 44 are formed. From FIGS. 3-5 one can see that neither the first adjoining face 32 nor the second adjoining face 42 is planar. Rather, they exhibit a conical shape with its center sloped downwardly. The cavity 29 inside the lower container body 20 is used to store liquids, such as the warm water before mixing, and the milk after the milk powder and the warm water are mixed.

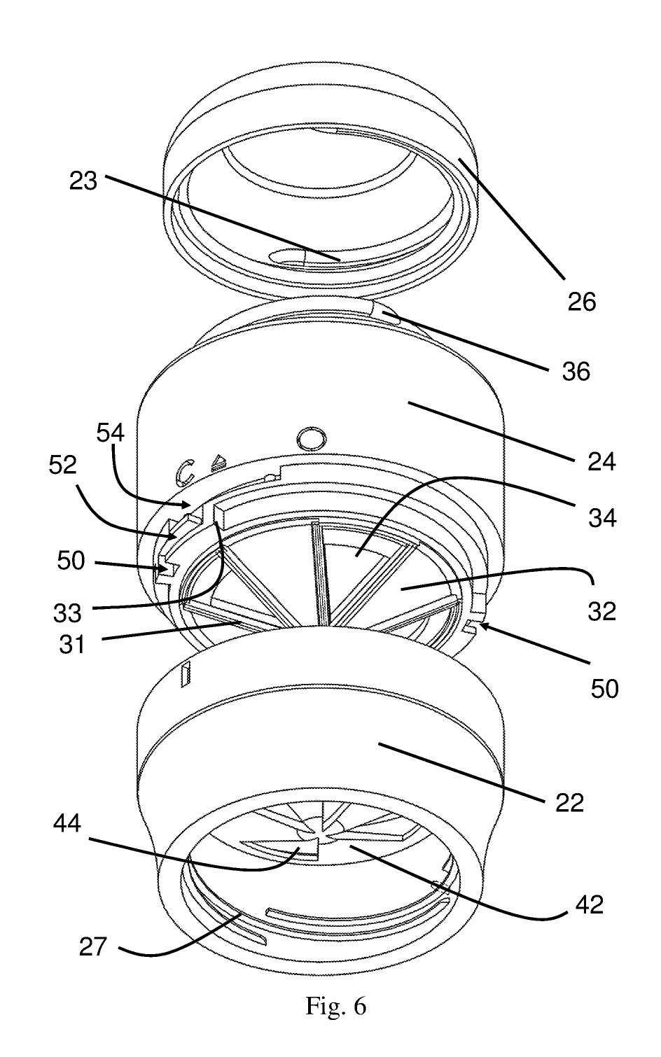

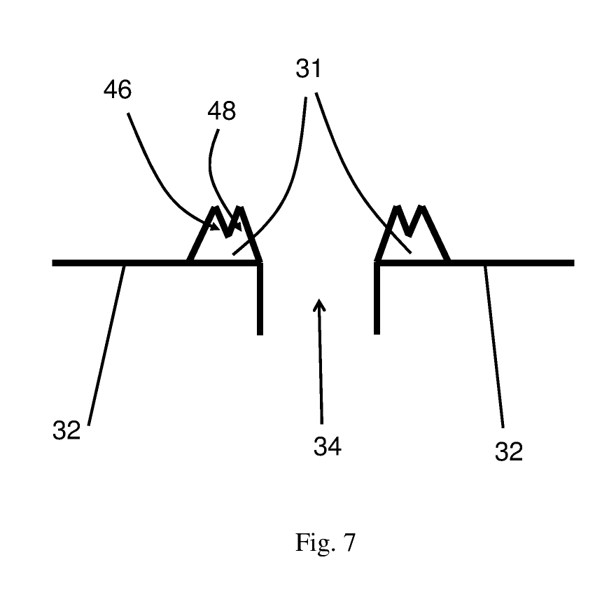

Now looking at FIGS. 6-7. In these drawings the structures of the first adjoining face 32 and the second adjoining face 42 are shown more clearly, and in these drawings the leak-proof cover 28 is not shown. The first adjoining face 32 and the second adjoining face 42 form the opening device of the portable feeding bottle, which can be switched between a first state and a second state as configured by the user. The first adjoining face 32 contains four openings 34 arranged equidistantly along the circumferential direction. The second adjoining face 42 similarly contains four openings 44 arranged equidistantly along the circumferential direction. Each of these openings 34 and 44 is in a fan shape, and each of these openings 34 has an area larger than that of each opening 44. In addition, at the edges of each of the openings 34 there are configured blocking members 31. The blocking members 31 are in strip shapes, and are made of silicone. The blocking members 31 completely surround all the edges of each opening 34. Also, as shown in FIG. 7 the blocking members 31 have sawtooth structures, and the bottom of a blocking member 31 (that is the end near the first adjoining face 32) has a larger width as compared to the top of the blocking member 31 (that is the end near the second adjoining face which is not shown in FIG. 7). In particular, on the top of a blocking member 31 there are two “V” shapes 46, 48. Such a structure results in that the width of the top of the blocking member 31 is smaller than that of its bottom. The two inverted “V” shapes 46, 48 together form a zigzag shape or say a sawtooth shape. Shapes 46 and 48 are also called V-type barriers.

FIG. 6 further shows the internal threads 23 of the container lid 26, and the internal thread 27 of the valve part 22.

FIG. 6 also shows the detailed structure of the slide tracks 33. Each slide track 33 includes an entry 50, a transition track 52, as well as a rotation track 54. On the storage part 24 there are two slide tracks 33 so there are in turn two sets of entry 50, transition track 52, and rotation track 54, which are configured on opposite positions on the circumferential direction. The entries 50 provide an entry direction which is the axial direction of the storage part 24. The transition tracks 52 extend along a direction which is the same as the circumferential direction of the storage part 24, and this is also the extending direction of the rotation tracks 54. The locking members 37 on the valve part 22 may enter the corresponding sliding tracks 33 through the entries 50, and then reach the rotation tracks 54 by passing through the transition tracks 52. By using such a sliding track design, the storage part 24 and the valve part 22, and thus the first adjoining face 32 and the second adjoining face 34, can rotate relative to each other.

Now the working principle of the portable feeding bottle as described above will be explained. With references to FIG. 1 to FIG. 7, before preparing to use the portable feeding bottle, the parts in FIG. 1 including the container lid 26, the storage part 24, the valve part 22 and the lower container body 20 are separate from each other. First of all, the user needs to assemble the storage part 24 and the valve part 22 together to form the complete upper container body. Then, the user makes the store part 24 and the valve part 22 rotate relative to each other, in order to configure the opening device in the first state. Here, the first state refers to a complete misalignment between the openings 34 and openings 44 on the first adjoining face 32 and the second adjoining face 42 which are formed on the storage part 24 and the valve part 22 respectively. That is, between the storage part 24 and the valve part 22 there is not any opening 34 overlapping at least partially with an opening 44 which would otherwise create a through hole. As a result, the milk powder stored in the storage part 24 at this time is prohibited from leaking out from the valve part 22 through the opening device. Next, before assembling the upper container body with the lower container body 20, the user firstly fill warm water for brewing the milk or water at any other temperature into the lower container body 20, and afterwards the user assemble the upper container body to the lower container body 20. Lastly, the user installs the container cover 26, as well as the optional leak-proof cover 28, on the upper container body. In this way, assembly of the feeding bottle is completed and the feeding bottle is ready to be taken out to street anytime.

The blocking members 31 having sawtooth shapes, which are arranged along the edges of the four openings 34 on the storage part 24, form effectively a seal between the openings 34 of the first adjoining face 32 and the openings 44 of the second adjoining face 42. The silicone material is sanitary and difficult to grow bacteria, and it can also achieve the effect of insulating heat and moisture. When the milk powder is yet to be brewed, the moisture generated by warm water located in the lower container body 20 is possible to enter the storage part 24 through the slits resulted from the middle portion of the valve part 22 staggering with the bottom of the storage part 24, and therefore affect quality of the milk powder. As mentioned above each blocking member 31 has a sawtooth shape since the silicone strip is wider at the top and narrower at the bottom. The wide-top-narrow-bottom design reduces contact area between the silicone strips and the valve part 22 to minimum, thus reducing the frictional force during rotation and in turn makes the rotation easier. The sawtooth shaped silicone strips provide the storage part 24 with more than one barrier to isolate the moisture, and thus more effectively keep the milk powder in the dry state. When the moisture accidentally passes through a first V-type barrier 46 (see FIG. 7), there is still another V-type barrier 48 which could prevent the moisture from flowing upwardly. The isolation of the moisture is therefore improved. Otherwise, without the blocking members 31 it is very easy for moistures from the warm water in the lower container body 20 to pass through the openings 34 and 44 on the first adjoining face 32 and the second adjoining face 42 even if they are misaligned to enter the interior of the storage part 24.

When it is needed to brew milk for the baby to drink, the user only needs to rotate the storage part 24 to make the openings 34 on the first adjoining face 32 to be at least partially overlapping with the openings 44 on the valve part 22. Then, milk powder is allowed to fall down to the interior of the lower container body 20, during which the opening device is at the second state. During this transition the first adjoining face 32 and the second adjoining face 42 are configured to rotate along the axis of the upper container body so as to switch the opening device between the first state and the second state.

Since both the first adjoining face 32 and the second adjoining face 42 are not planar, but rather conical, within the valve part 22 and at the bottom of the storage part 24 there are actually formed funnel structures which slope downwardly. The design of the sloping helps the milk powder to fall down more effectively, which leaves less milk powder in the storage part 24 as compared to designs in which the bottoms are planar.

If the openings 34 and the opening 44 are completely aligned, then the milk powder will fall down at the fastest speed. If the openings 34 and the opening 44 are only partially aligned, then the milk powder will fall down at a slower speed, because the area of the through hole thus formed will be smaller. Afterwards, when a required amount of milk powder has fallen into the lower container body 20, the storage part 24 can be rotated along a reverse direction again, so that after the milk powder has fallen into the lower container body 20, the feeding bottle can be shaken thoroughly to brew the milk which is suitable for drinking. Rotating the storage part 24 reversely would return the opening device to the first state, which then prevents further, unnecessary milk powder from falling into the lower container body 20.

When the storage part 24 rotates, the blocking members 31 with the sawtooth design function to sweep away the milk powder, making it difficult to reside between the storage part 24 and the valve part 22. Otherwise, during the process of the openings 34 and 44 moving from misplacement to alignment so that milk powder falls down to the lower container body 20, it is easy to cause the milk powder to reside between the first adjoining face 32 and the second adjoining face 34.

After the milk brewing is completed, the valve part 22 can be detached from the lower container body 20, and the container lid 26 can also be removed from the storage part 24. Finally, the container lid is directly screwed to the lower container body 20. As a result, the infant can drink milk in the feeding bottle through an opening or a teat on the container lid 26.

When it is required to clean the portable feeding bottle, the user just need to dissemble the feeding bottle by separating all parts including the storage part 24 and the valve part 22. Consequently, the container lid 26, the storage part 24, the valve part 22 as well as the lower container body 20 can all be thoroughly cleaned, both inside and outside, including in particular the first adjoining face 32 and the second adjoining face 34 on the storage part 24 and the valve part 22 and the sawtooth structure on the blocking members 31.

Therefore, after the above embodiments are described, those skilled in the art could realize that different modifications and equivalents can be used without departing from the essence of the present invention. Accordingly, the above descriptions should not be deemed to limit the scope of invention as encompassed by the claims appended below.

For example, although the embodiments of portable containers described above is a portable feeding bottle, those skilled in the art should realize that the same container can also be used for mixing different types solid substance (powder) and water, such as instant coffee, etc. Therefore, the scope of the invention is not limited to baby feeding bottles.

1. A portable container, comprising:
a lower container body for storing a liquid;
an upper container body detachably connected to the lower container body, the upper container body adapted to store a solid substance;
wherein, the upper container body further comprises a user-configurable opening device which is switchable between a first state and a second state; in the first state the opening device preventing the solid substance in the upper container body from falling into the lower container body; in the second state the opening device allowing the solid substance to fall into the lower container body in order to mix with the liquid.

2. The portable container according to claim 1, wherein the opening device comprises a first adjoining face, and a second adjoining face which is movable relative to the first adjoining face; each of the first and second adjoining faces comprising an opening; in the first state of the opening device, the opening on the first adjoining face being completely misaligned with the opening on the second adjoining face; in the second state of the opening device, the opening on the first adjoining face being at least partially aligned with the opening on the second adjoining face.

3. The portable container according to claim 2, wherein on the first adjoining face there is configured a blocking member;
the blocking member surrounding edges of the opening on the first adjoining face; the blocking member adapted to form a seal between the opening on the first adjoining face and the opening on the second adjoining face.

4. The portable container according to claim 3, wherein the blocking member is a silicone strip.

5. The portable container according to claim 3, wherein the blocking member has a sawtooth structure on its top contacting the second adjoining face.

6. The portable container according to claim 3, wherein a top of the blocking member contacting the second adjoining face has a smaller width as compared to a bottom of the blocking member contacting the first adjoining face.

7. The portable container according to claim 2, wherein the upper container body has a circular cross-sectional shape; the first adjoining face and the second adjoining face configured to be rotatable around a central axis of the upper container body so as to allow the opening device to switch between the first state and the second state.

8. The portable container according to claim 7, wherein both the first adjoining face and the second adjoining face have a conical shape.

9. The portable container according to claim 1, wherein the upper container body further comprises a valve part, and a storage part for storing the solid substance; the valve part connected between the storage part and the lower container body, the three of which are detachably connected to each other; the first adjoining face located at the bottom of the storage part; the second adjoining face located at the top of an end of the valve part adjacent to the storage part.

10. The portable container according to claim 1, wherein the openings on the first adjoining face and the second adjoining face are in funnel shapes.

11. The portable container according to claim 1, wherein the opening on the first adjoining face has an area larger than that of the opening on the second adjoining face.

12. The portable container according to claim 1, further comprises a container lid removably connected to the upper container body.

13. The portable container according to claim 12, further comprises a leak-proof cover located between the container lid and the upper container body.

14. A method of configuring a portable container to mix a solid substance with a liquid, the portable container comprising an upper container body, and a lower container body detachably connected to the upper container body; the upper container body further comprising a user-configurable opening device; the method comprising the steps of:
loading the liquid into the lower container body;
configuring the opening device of the upper container body in a first state;
loading the solid substance into the upper container body, and connecting the upper container body to the lower container body;
configuring the opening device of the upper container body in a second state, in which the solid substance enters the lower container body from the upper container body to mix with the liquid;
wherein, the upper container body further comprises a user-configurable opening device which is switchable between a first state and a second state; in the first state the opening device preventing the solid substance in the upper container body from falling into the lower container body; in the second state the opening device allowing the solid substance to fall into the lower container body in order to mix with the liquid.

15. The method according to claim 14, wherein the opening device comprises a first adjoining face, and a second adjoining face which is movable relative to the first adjoining face; each of the first and second adjoining faces comprising an opening; in the first state of the opening device, the opening on the first adjoining face being completely misaligned with the opening on the second adjoining face; in the second state of the opening device, the opening on the first adjoining face being at least partially aligned with the opening on the second adjoining face.

16. The method according to claim 15, wherein on the first adjoining face there is configured a blocking member; the blocking member surrounding edges of the opening on the first adjoining face; the blocking member adapted to form a seal between the opening on the first adjoining face and the opening on the second adjoining face.

17. The method according to claim 16, wherein the blocking member has a sawtooth structure on its top contacting the second adjoining face.

18. The method according to claim 16, wherein a top of the blocking member contacting the second adjoining face has a smaller width as compared to a bottom of the blocking member contacting the first adjoining face.

19. The method according to claim 15, wherein both the first adjoining face and the second adjoining face have a conical shape.

20. The method according to claim 14, wherein the opening on the first adjoining face has an area larger than that of the opening on the second adjoining face.
